(19) United States
(12) Patent Application Publication
(10) Pub. No.: US 2015/0134580 A1
(43) Pub. Date: May 14, 2015

(54) Method And System For Training A Neural Network

(71) Applicant: Persyst Development Corporation, San Diego, CA (US)

(72) Inventor: Scott B. Wilson, Del Mar, CA (US)

(73) Assignee: Persyst Development Corporation, San Diego, CA (US)

(21) Appl. No.: 14/078,497

(22) Filed: Nov. 12, 2013

(51) Int. Cl. G06N 3/08

(52) U.S. Cl. CPC G06N 3/08
USPC 706/25

(57) ABSTRACT

A method and system for training a neural network is disclosed herein. A processor is configured to train a neural network to learn to generate a plurality of sub-concept outputs from a first plurality of inputs of the plurality of digital input signals. The processor is also configured to use the plurality of sub-concept outputs as a plurality of target outputs for a plurality of top-level inputs of the plurality of digital input signals.

### CROSS REFERENCES TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

The present invention generally relates to neural networks. More specifically, the present invention relates to a method and system for training a neural network.

2. Description of the Related Art

Artificial neural networks are computational models capable of machine learning and pattern recognition. The artificial neural network generally is interconnected neurons that compute values from inputs by feeding data through the artificial neural network. Artificial neural networks have application in numerous areas including voice recognition, medical diagnosis, finance, trading, facial recognition, chemistry, game playing, decision making, robotics, and the like.

Using the Statistica Automated Neural Networks package, as shown in FIGS. 1-2, “Select variables for analysis” window 100 and “SANN—Automated Network Search” window 150, respectively, training twenty NNS is proposed, with fifteen inputs and one output variables, under Train/Retrain Networks 15 in FIG. 2, and with hidden unit counts varying from 5 to 16, under Network Types MLP 20.

The five-hidden-unit NN has 82 weights that can be varied during the training phase, and the sixteen-hidden-unit NN has 257 weights. With this many degrees of freedom, it can be difficult to ensure the training set has enough cases to fully represent all regions of the fifteen-dimensional input space. This is exacerbated when some or all of the inputs are unbounded. Additionally, when inputs are unbounded, a single out-of-range input may overwhelm the contributions of all the other inputs—as is common with outlier cases. This may be addressed by preprocessing the input variables so that they are bounded by minimum or maximum values. However, this method may hide the fact that the example is truly an outlier and should be rejected out of hand.

FIG. 3 shows a graphical depiction of the MLP architecture with six inputs, three hidden nodes and a single output. For future reference herein, three of the inputs 30b should be considered together, i.e., they form the basis for a sub concept of the top-level concept. The other three inputs, 40b represent a second sub-concept. Traditionally, the inputs from all sub-concepts are mixed together as shown in the NN of FIG. 3.

General definitions for terms utilized in the pertinent art are set forth below.

Boolean algebra is the subarea of algebra in which the values of the variables are the truth values true and false, usually denoted 1 and 0 respectively.

A Boolean network (BN) is a mathematical model of biological systems based on Boolean logic. The BN has a network structure consisting of nodes that correspond to genes or proteins. Each node in a BN takes a value of 1 or 0, meaning that the gene is or is not expressed.

Fuzzy logic is a form of many-valued logic; it deals with reasoning that is approximate rather than fixed and exact. Compared to traditional binary sets (where variables may take on true or false values) fuzzy logic variables may have a truth value that ranges in degree between 0 and 1. Fuzzy logic has been extended to handle the concept of partial truth, where the truth value may range between completely true and completely false. Furthermore, when linguistic variables are used, these degrees may be managed by specific functions. Irrationality can be described in terms of what is known as the “fuzzjective”.

Multilayer perceptron (“MLP”) is a feedforward artificial neural network model that maps sets of input data onto a set of appropriate outputs. An MLP consists of multiple layers of nodes in a directed graph, with each layer fully connected to the next one. Except for the input nodes, each node is a neuron (or processing element) with a nonlinear activation function.

Neural network (“NN”) is an interconnected group of natural or artificial neurons that uses a mathematical or computational model for information processing based on a connectionistic approach to computation. In more practical terms neural networks are non-linear statistical data modeling or decision making tools. They can be used to model complex relationships between inputs and outputs or to find patterns in data.

Perceptron is a simple model of an artificial neuron which can predict boolean events after having been trained on past events. The perceptron is specified by the number of inputs N, and the weights connecting the inputs to the output node. The weights are the parameters which must be either set by hand or learned by a learning algorithm.

ROC curve (receiver operating characteristic) is a graphical plot of test sensitivity as the y coordinate versus its 1 minus specificity or false positive rate (FPR), as the x coordinate. The ROC curve is an effective method of evaluating the performance of diagnostic tests.

“Amplitude” refers to the vertical distance measured from the trough to the maximal peak (negative or positive). It expresses information about the size of the neuron population and its activation synchrony during the component generation.

The term “analogue to digital conversion” refers to when an analogue signal is converted into a digital signal which can then be stored in a computer for further processing. Analogue signals are “real world” signals (e.g., physiological signals such as electroencephalogram, electrocardiogram or electrooculogram). In order for them to be stored and manipulated by a computer, these signals must be converted into a discrete digital form the computer can understand.

“Artifacts” are electrical signals detected along the scalp by an EEG, but that originate from non-cerebral origin. There are patient related artifacts (e.g., movement, sweating, ECG, eye movements) and technical artifacts (50/60 Hz artifact, cable movements, electrode paste-related).

The term “differential amplifier” refers to the key to electrophysiological equipment. It magnifies the difference between two inputs (one amplifier per pair of electrodes).

“Duration” is the time interval from the beginning of the voltage change to its return to the baseline. It is also a measurement of the synchronous activation of neurons involved in the component generation.

“Electrode” refers to a conductor used to establish electrical contact with a nonmetallic part of a circuit. EEG electrodes are small metal discs usually made of stainless steel, tin, gold or silver covered with a silver chloride coating. They are placed on the scalp in special positions.

“Electrode gel” acts as a malleable extension of the electrode, so that the movement of the electrodes leads is less likely to produce artifacts. The gel maximizes skin contact and allows for a low-resistance recording through the skin.

The term “electrode positioning” (10/20 system) refers to the standardized placement of scalp electrodes for a classical EEG recording. The essence of this system is the distance in percentages of the 10/20 range between Nasion-Inion and fixed points. These points are marked as the Frontal pole (Fp), Central (C), Parietal (P), occipital (O), and Temporal (T). The midline electrodes are marked with a subscript z, which stands for zero. The odd numbers are used as subscript for points over the left hemisphere, and even numbers over the right

“Electroencephalogram” or “EEG” refers to the tracing of brain waves, by recording the electrical activity of the brain from the scalp, made by an electroencephalograph.

“Electroencephalograph” refers to an apparatus for detecting and recording brain waves (also called encephalograph).

“Epileptiform” refers to resembling that of epilepsy <an epileptiform abnormality>.

“Filtering” refers to a process that removes unwanted frequencies from a signal.

“Filters” are devices that alter the frequency composition of the signal.

“Ideal frequency-selective filter” is a filter that exactly passes signals at one set of frequency and completely rejects the rest. There are three types of filter: “Low frequency” or in old terminology “high pass”. Filters low frequencies. “High frequency” or in old terminology “low pass”. Filters high frequencies. “Notch filter”. Filters one frequency, usually 60 Hz. “Real filters” or “hardware filters” alter the frequency composition of the signal. After filtering the signal, the frequencies that have been filtered cannot be recovered. “Digital filters” change the frequency of the signal by performing calculations on the data.

“Frequency” refers to rhythmic repetitive activity (in Hz). The frequency of EEG activity can have different properties including: “Rhythmic”. EEG activity consisting in waves of approximately constant frequency. “Arrhythmic”. EEG activity in which no stable rhythms are present. “Dysrhythmic”. Rhythms and/or patterns of EEG activity that characteristically appear in patient groups or rarely or seen in healthy subjects.

“Montage” means the placement of the electrodes. The EEG can be monitored with either a bipolar montage or a referential one. Bipolar means that there are two electrodes per one channel, so there is a reference electrode for each channel. The referential montage means that there is a common reference electrode for all the channels.

“Morphology” refers to the shape of the waveform. The shape of a wave or an EEG pattern is determined by the frequencies that combine to make up the waveform and by their phase and voltage relationships. Wave patterns can be described as being: “Monomorphic”. Distinct EEG activity appearing to be composed of one dominant activity. “Polymorphic”. distinct EEG activity composed of multiple frequencies that combine to form a complex waveform. “Sinusoidal”. Waves resembling sine waves. Monomorphic activity usually is sinusoidal. “Transient”. An isolated wave or pattern that is distinctly different from background activity.

“Spike” refers to a transient with a pointed peak and a duration from 20 to under 70 msec.

The term “sharp wave” refers to a transient with a pointed peak and duration of 70-200 msec.

The term “neural network algorithms” refers to algorithms that identify sharp transients that have a high probability of being epileptiform abnormalities.

“Noise” refers to any unwanted signal that modifies the desired signal. It can have multiple sources.

“Periodicity” refers to the distribution of patterns or elements in time (e.g., the appearance of a particular EEG activity at more or less regular intervals). The activity may be generalized, focal or lateralized.

“Sampling” or the term “sampling the signal” refers to reducing a continuous signal to a discrete signal. A digital signal is a sampled signal; obtained by sampling the analogue signal at discrete points in time.

The term “sampling interval” is the time between successive samples; these points are usually evenly spaced in time.

The term “sampling rate” refers to the frequency expressed in Hertz (Hz) at which the analogue-to-digital converter (ADC) samples the input analogue signal.

The term “Signal to Noise Ratio” (SNR) refers to a measurement of the amplitude of variance of the signal relative to the variance of the noise.

An EEG epoch is an amplitude of a EEG signal as a function of time and frequency.

A significant downside of NNs is their inability to explain their reasoning, especially when they incorrectly identify a case. This is in stark contrast to an expert system, which is made up of many small rules, such as “is the event large enough to be an eye blink?”, and “does the event display the expected electrical field across the scalp?”, An incorrect output from an expert system can often be localized to the incorrect coding of a single rule, which can then be tweaked without recoding the complete system. Also, exceptional cases, e.g. outliers, can be handled by adding extra rules. Thus, there is a need for improving training of neural networks.

### BRIEF SUMMARY OF THE INVENTION

The present invention provides a solution to the shortcomings of the prior art. The present invention provides a method and system for training a neural network.

One aspect of the present invention is a system for training a neural network. The system includes a source for generating a plurality of digital input signals, a processor connected to the source to receive from the plurality of digital input signals from the source, and a display connected to the processor for displaying a final output. Preferably, the processor is configured to train a neural network to learn to generate a plurality of sub-concept outputs from a first plurality of inputs of the plurality of digital input signals. The processor is also configured to use the plurality of sub-concept outputs as a plurality of target outputs for a plurality of top-level inputs of the plurality of digital input signals.

Another aspect of the present invention is a method for training a neural network. The method includes generating a plurality of digital input signals from a machine comprising a source, a processor and a display, training a neural network to learn to generate a plurality of sub-concept outputs from a first plurality of inputs of the plurality of digital input signals, and using the plurality of sub-concept outputs as a plurality of target outputs for a plurality of inputs (the union of those used for the sub-concepts) of the plurality of digital input signals.

Yet another aspect of the present invention is a system for training a neural network for detecting artifacts in EEG recordings. The system includes a plurality of electrodes for generating a plurality of EEG signals, a processor connected to the plurality of electrodes to generate an EEG recording from the plurality of EEG signals, and a display connected to the processor for displaying an EEG recording. Preferably, the processor is configured to train a neural network to learn to generate a plurality of sub-concept outputs from a first plurality of inputs. The processor is also configured to use the plurality of sub-concept outputs as a plurality of target outputs for a plurality of top-level inputs.

Preferably, the plurality of top-level inputs comprises at least one of CorrFp, AsymFp, DelFp, CorrF, RatF, AsymF, CorrO, RatO, AsymO, HgtLFp, HgtRatLRFp, DurLFp, AlpLFp, DurRFp, and AlphRFp.

Preferably, the plurality of target outputs comprises at least one of VEyeIsTrue, FieldFP, FieldF, FieldO, MorphHgt, MorphL and MorphR.

Yet another aspect of the present invention is a method for training a neural network for detecting artifacts in EEG recordings The method includes generating a plurality of EEG signals from a machine comprising a plurality of electrodes, an amplifier and processor, training a neural network to learn to generate a plurality of sub-concept outputs from a first plurality of inputs, and using the plurality of sub-concept outputs as a plurality of target outputs for a plurality of top-level inputs.

Having briefly described the present invention, the above and further objects, features and advantages thereof will be recognized by those skilled in the pertinent art from the following detailed description of the invention when taken in conjunction with the accompanying drawings.

### BRIEF DESCRIPTION OF THE SEVERAL VIEWS OF THE DRAWINGS

FIG. 1 illustrates a variables window of an application, Statistica Automated Neural Networks.

FIG. 2 illustrates an ANS window of an application, Statistica Automated Neural Networks.

FIG. 3 is a block diagram of an MPL architecture.

FIG. 4 is a plot diagram of a transfer function in general.

FIG. 5 is a plot diagram of a transfer function with two hidden nodes.

FIG. 6 is a plot diagram of a transfer function of an over trained NN.

FIG. 7 is a block diagram a hierarchical NN configuration.

FIG. 8 is a block diagram an IONN configuration.

FIG. 9 is a graph of a 3D transfer function with the output of the sub-concept NN.

FIG. 10 is a graph of a 3D transfer function with the learned value of the IONN.

FIG. 11 is a block diagram of an EEG machine component of an EEG system.

FIG. 12 is an illustration of an EEG system used on a patient.

FIG. 13 is a map representing the international 10-20 electrode system for electrode placement for an EEG.

FIG. 14 is a detailed map representing the intermediate 10% electrode positions, as standardized by the American Electroencephalographic Society, for electrode placement for an EEG.

FIG. 15 is a block diagram of a system for analyzing an EEG recording.

### DETAILED DESCRIPTION OF THE INVENTION

The present invention will be described herein using an exemplary problem of creating a classification algorithm to recognize eye blink artifacts in electroencephalography (EEG) recordings. The presence of these non-cerebral signals can confound visual presentation of the EEG by frequency domain methods, e.g. FFT.

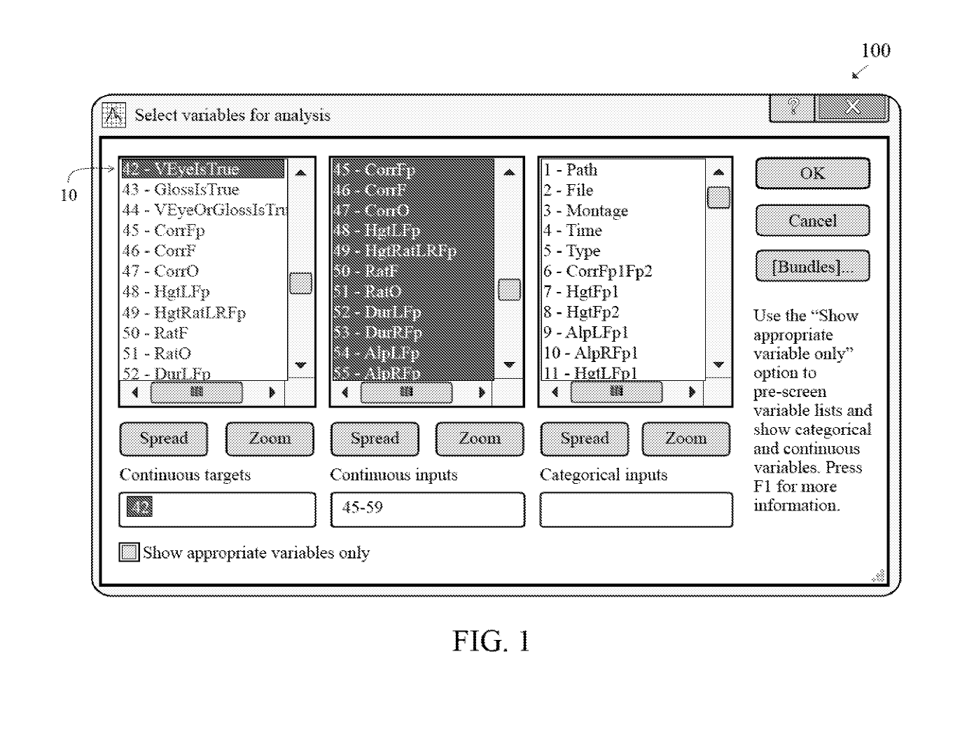

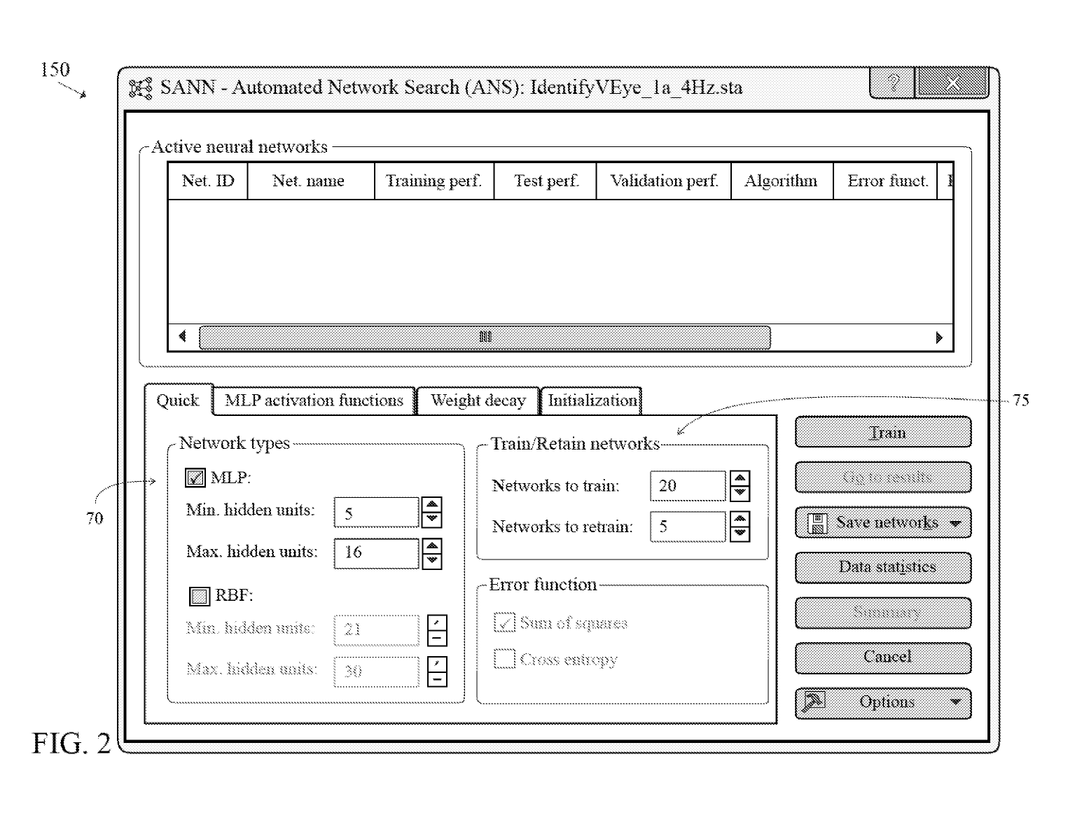

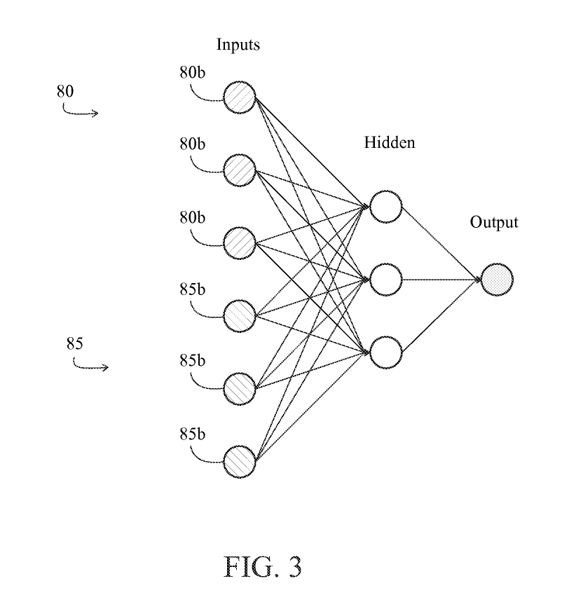

FIGS. 1-2 show screen shots of different windows of an application, Statistica Automated Neural Networks. In the example illustrated, there are fifteen measurements (e.g. amplitude, duration and inter-channel correlation) of a candidate eye blink that describe its morphology and electrical field distribution across the scalp. For training data there is a set of true-positive cases, eye blinks marked by a human reader, and true negative cases found by scanning for candidate waveform deflections in artifact-free sections of EEG.

NN Inputs

The fifteen measurements are continuous-valued and often unbounded, e.g. there is no maximum height. These measurements, with perhaps some preprocessing, become the inputs to the neural network (NN) that will be trained with the true-positive and true-negative cases and then later used to classify unknown cases.

Single Output: Concept Learning as Fuzzy Boolean

The concept to learn, “is this an eye blink?,” is given the name VeyelsTrue 10. True-positive cases are assigned a value of VEyelsTrue=1 and true-negative cases are assigned a value of VEyelsTrue=0. The example herein follows the standard practice of employing a regression (rather than classification) multilayer perceptron (MLP) to solve this two-class problem. The VEyelsTrue variable is used as the target output value for each case during the training phase. After the NN is trained, the predicted VEyelsTrue value computed by the NN is continuous-valued, varying from 0.0 to 1.0—a fuzzy Boolean. (In actuality, higher and lower values are sometimes produced for outlier cases). VEyelsTrue predictions on a group of cases with known classifications can be compared against a threshold to generate a ROC (receiver operating characteristic) curve where the tradeoff between sensitivity and specificity is displayed.

NN as Black-Box

As mentioned above, a significant downside of NNs is their inability to explain their reasoning, especially when they incorrectly identify a case. This is in stark contrast to an expert system, which is made up of many small rules, such as “is the event large enough to be an eye blink?”, and “does the event display the expected electrical field across the scalp?”. An incorrect output from an expert system can often be localized to the incorrect coding of a single rule, which can then be tweaked without recoding the complete system. Also, exceptional cases, e.g. outliers, can be handled by adding extra rules.

Breaking Problem into Parts: NN-Rules as Explainers

The present invention breaks the monolithic, black-box NN into a handful of smaller NNs. Each small NN represents what might be coded as a single rule in an expert system, herein called “NN-Rules”. Generally, more than two or three inputs to each NN-Rule is not allowed, which makes it possible to easily view the NN's transfer function, the plots of the output variable displayed as a function of one or two of the inputs. With some experience, these transfer functions can be translated into natural language, such as “an eye blink is larger than 35 uV and smaller than 400 uV”.

In one example, six NN-rules are created. Three of the rules (FieldFp, FieldF and FieldO) decide whether the expected electrical field at three positions on the scalp (frontal-polar, frontal and occipital) is seen. One of the rules decides whether the amplitude of the eye blink is as expected (MorphHgt), and two of the rules decide whether the eye blink morphology of the half-wave segments to the left and right (before and after) of the eye blink tip is correct (MorphL and MorphR). The fuzzy Boolean outputs of these six rules will be combined to yield the final VEyelsTrue output.

A simple computation is performed to generate a lower bound on the number of training cases that are required to train a fifteen input NN. Then the lower bound generated will be compared with the number of training cases required to train six sub-concept NNs, which each have three inputs. Using the most conservative calculation, in which the assumption is that the inputs are Boolean (taking only the values zero or one), then 2^{N} cases are needed to provide an example for each possible corner of the N-dimensional hypercube: 2¹⁵=32,768 cases. Whereas the six sub-concept NNs require 6*2³=48 cases, a reduction by nearly a factor of 700.

In practice, far more than this is needed because many of the corners will correspond to rare occurrences and the inputs are not Boolean, but rather unbounded and continuous with preferred intermediate values, implying at least three cases per dimension. This is expected to even further increase the relative training set needs.

Problem: Unknown Sub-Concept Classifications

In order to learn the top-level concept “is this an eye blink?” it is necessary to train sub-concepts “is the frontal-polar field correct for an eye blink?” for each NN-Rule. As a general practice, this subconcept information is not available for the training cases. That is, the human expert marked only the time at which eye blink occurred, but did not provide data on whether the correct field was displayed in the frontal-polar and occipital scalp positions. As a surrogate for the answer to “is the frontal-polar field correct for an eye blink?,” the answer to the question “is this an eye blink?” is used.

In the example given, the sub-concept representing the question “is the frontal-polar field correct for an eye blink?” is named FieldFp. This NN-Rule has three inputs (CorrFp, AsymmFp and DelFp) and one output, FieldFp, which is replaced by the surrogate variable VEyelsTrue during training

Subsampling for Sub-Concept Refinement

The input variables for the FieldFp rule represent the correlation between Fp1 and Fp2 (CorrFp), the amplitude asymmetry between Fp1 and Fp2. (AsymmFp), and the time difference between the amplitude peaks in Fp1 and Fp2 (DelFp). A prototype eye blink will have nearly identical waveforms in the Fp1 and Fp2 channels, yielding input values CorrFp=1.0 AsymmFp=0.0 and DelFp=0.0.

However, glossokinetic artifacts (forward and backward movement of the tongue) also have a large frontal-polar field and prototype events will have input values CorrFp=1.0, AsymmFp=0.0 and DelFp=0.0, identical to prototype eye blinks. Glossokinetic cases have the value VEyelsTrue=0.0, so improved NN performance is obtained by excluding them from the training of the FieldFp rule. Discrimination between eye blink and glossokinetic artifacts must occur in another NN-rule.

Below are the six NN-rules described by their sub-concept name (identified as the output variable ame), the names of their input variables and the number of hidden nodes. Each NN-rule was trained many times, with the number of hidden nodes ranging from one to three, and the instance with the highest validation accuracy was selected.

Output=(FieldFP), Input=(CorrFp, AsymFp, DelFp), Hidden=3,

Output=(FieldF), Input=(CorrF, RatF, AsymF), Hidden=3.

Output=(FieldO), Input=(CorrO, RatO, AsymO), Hidden=3.

Output=(MorphHgt), Input=(HgtLFp, HgtRatLRFp), Hidden=3.

Output=(MorphL), Input=(DurLFp, AlpLFp), Hidden=3.

Output=(MorphR), Input=(DurRFp, AlphRFp), Hidden=3.

Propagation of Uncertainty

In practice, no real eye blink will have a perfect electric field or morphology, there is no expectation that every eye blink will have a predicted value of FieldFp=1.0, FieldF=1.0, Field0=1.0, etc. Instead, the expected values of an eye blink may be FieldFp=0.8, FieldF=0.2 and Field0=0.7. Fuzzy Boolean values near 0.5 reflect the highest level of uncertainty about the truth of the concept. These values become the inputs to the combiner NN-Rule. Given two eye blinks with identical input values, except one has FieldF=0.2 and the other has FieldF=0.5, the expectation is that the combiner NN-Rule will have a larger value of VEyelsTrue for the second eye blink.

This methodology of using fuzzy Booleans plays a similar role to certainty factors in expert systems. It also allows for the avoidance of using hard cutoff thresholds, which can result in significantly different classifications for very similar cases.

Using Domain Knowledge

In many cases, the domain expert, in the example herein, the neurologist, has a significant amount of domain knowledge about what the sub-concepts are and how they are affected by various inputs. Example rules are:
eye blinks should be larger than 35 uV
eye blinks should be smaller than 600 uV
eye blinks should have similar amplitude in contralateral channels
the eye blink signal should decrease towards the back of the head

When possible, the NNs developed should be verified to be consistent with the rules aforementioned.

Tendency Rules

The rules above are not traditional rules in the sense that they are expected true in every case, but rather the rules describe a causal connection or a statistical correlation that has been observed by the expert. The rule, “eye blinks should be larger than 35 uV” to mean the following: given two candidate eye blinks that are identical in every respect except their heights, which are 20 uV and 40 uV respectively, the larger candidate will be assigned a somewhat higher VEyelsTrue probability, maybe 0.67 vs. 0.73. Diminishing returns may be expected to the increasing eye blink probability as it gets larger, until the point of reaching the rule, “eye blinks should be smaller than 600 uV”, where the probability to start decreasing is expected as the height exceeds 600 uV. Thus, any rule that applies to the current case serves to increase or decrease the probability that the candidate is an eye blink.

A shorthand notation is developed for the tendency rules, where the operator “≈>” expresses the sentiment “weakly implies.” The rules above can thus be written as:
height>35 uV≈>VEye=true
height>600 uV≈>VEye=false
left_height≈right_height≈>VEye=true
frontal_polar height>central_height>occipital_height≈>VEye=true

Limiting Transfer Function Complexity

In many cases, the general shape of the transfer function is known, which is the plot of the NN's output as a function of one or more input variables. Given the tendency rule:
height>35 uV≈>VEye=true;

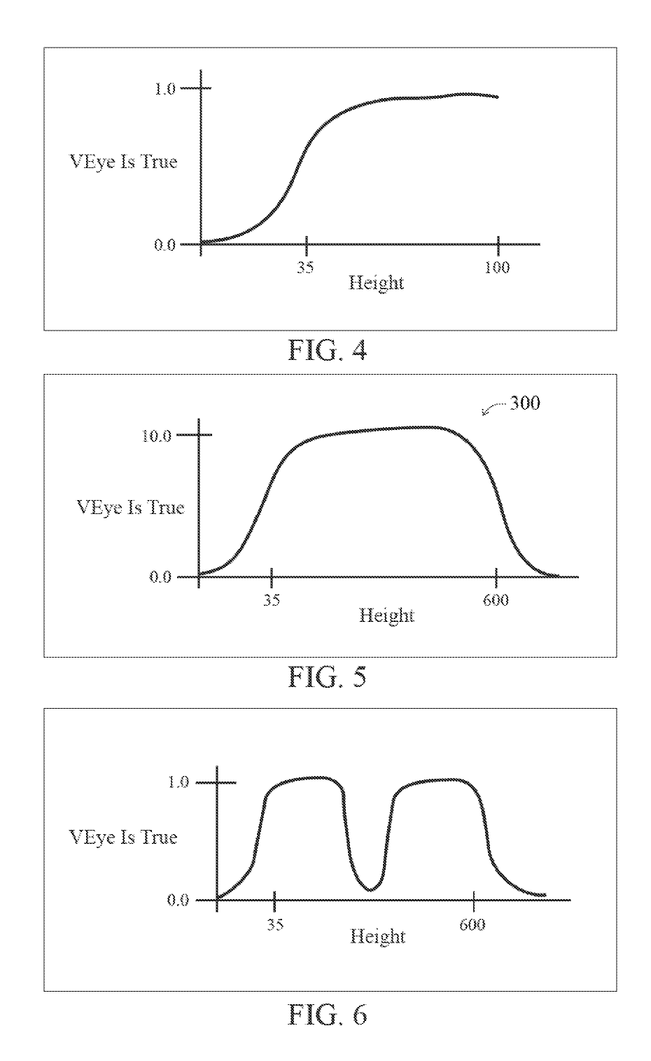

The expected transfer function will look something like the plot shown in FIG. 4. In particular, it is expected that the function VEyelsTrue(height) is a monotonically increasing function and has a value of 0.5 near the point height=35 uV. One way to enforce the “monotonically increasing” constraint on the transfer function is by setting the NN's number of hidden nodes to one. Once the NN is trained, the transfer function can then be plotted and verified that it is increasing (rather than decreasing) and has a value of 0.5 at some point near height=35 uV.

Given the two tendency rules:
height>35 uV≈>VEye=true;
height>600 uV≈>VEye=false;

The expected transfer function will look something like the plot shown in FIG. 5. Simple bump shapes 300, like the one shown in FIG. 5, can be allowed by increasing the number of hidden nodes to two.

If more than two hidden nodes is allowed, it's important to verify that the transfer function does not include unexpected complexity, as shown in FIG. 6. This would be an indication that the NN is over trained.

Three-dimensional transfer functions can also be used in this manner, with two inputs on the X and Y axes and the NN output on the Z axis. More inputs can be investigated via slices through the non-displayed inputs.

Combining Sub-Concepts

After the sub-concept NNs have been trained, their outputs are used as the inputs to a final-stage combiner NN. In example herein, this means that the outputs of the FieldFp, FieldF, FieldO, MorphHgt, MorphL and MorphR NNs are used as inputs and trained to match the final VEyelsTrue output.

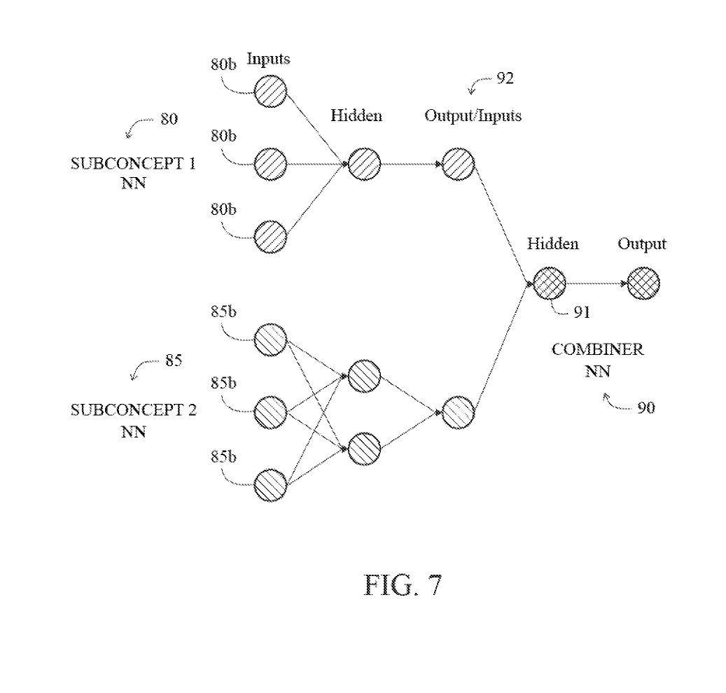

FIG. 7 shows a simplified drawing of this hierarchical NN configuration with two sub-concept NNs 80b and 85b, and a top-level combiner NN 90 with one hidden node 91.

In most cases, the combiner NN 90 requires only a single hidden node 91, i.e. it is a monotonically increasing or decreasing function of the inputs. A single hidden node can generate logic equivalent to fuzzy AND and OR, along with negation applied to any of the inputs. Two hidden nodes are required to generate the logic of the fuzzy XOR.

In the presented eye blink example, the combiner NN 90 is described as:
Output={VeyelsTrue}, Input={FieldFP, FieldF, FieldO, MorphHgt, MorphL, MorphR}, Hidden=1

Tradeoff: Accuracy vs. Understanding

In many cases, the intermediate training of sub-concept NNs, which are then combined, results in decreased accuracy compared to the standard monolithic NN that uses all inputs and many hidden nodes. Some loss in classification accuracy is traded for two benefits:
a classifier (constructed of NN-rules) that can explain its reasoning,
a classifier that fares better on novel data due to its reduced need for large training sets.

Sub-Concept Training Errors

Some of the loss in accuracy may be due to the fact that the sub-concepts learn redundant patterns, since they don't “know” that these patterns may be represented better in sibling sub-concepts. Additionally, as described in the example herein, the sub-concepts may suffer some learning errors through use of the surrogate target variable during training

IONN: High Accuracy with Explanation

The Inside-Out Neural Network (IONN) was developed as a method to circumvent this tradeoff in accuracy vs. explanation. All of the methods described above will still be employed, however, rather than using a combiner NN, a NN is trained with all inputs and an increased number of outputs. The outputs variables the IONN must learn consist of the top-level concept, e.g. VEyelsTrue, as well as all of the subconcepts, e.g. FieldFp, FieldF, FieldO, MorphHgt, MorphL and MorphR. Forcing the IONN to learn the sub-concepts limits the number of potential models that fit both the input and output data. That is, the sub-concept targets work as constraints that ensure the NN “gets the right answer for the right reason.” Additionally, like the combiner NN model, the sub-concept outputs function as explainers of the NN's reasoning.

The IONN typically has the same accuracy (on the top-level concept) as a traditional NN trained with a similar number of hidden nodes. The accuracy of the IONN on the sub-concept outputs is usually extremely high, with correlations >0.9. If this level of accuracy isn't obtained for the sub-concepts, this often is an indication that more hidden nodes are required. As with all NN models, some testing is required to find the “correct” number of hidden nodes. The best practice developed for the present invention is to start training the IONN with a number of hidden nodes equal to the number of sub-concepts. The number of hidden nodes is increased until each of the NN's sub-concept outputs has a correlation>=0.95 with their respective target values.

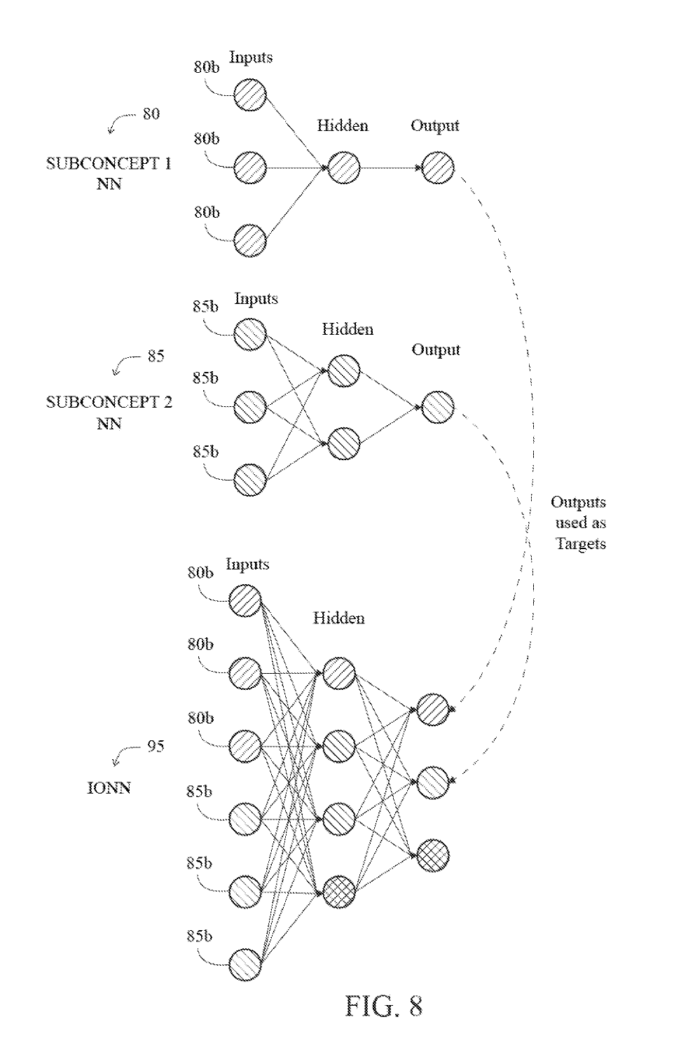

FIG. 8 shows the network architecture of the IONN model 95 with two sub-concepts 80 and 85. The sub-concepts are trained first, and then their outputs are used as additional targets of the IONN. This contrasts with the combiner NN 90, which uses the sub-concept outputs as inputs 92. The inputs of the IONN are the union of inputs from the sub-concept NNs 80b and 85b.

The system includes a source for generating the digital input signals, a processor connected to the source to receive from the plurality of digital input signals from the source, and a display connected to the processor for displaying a final output. Preferably, the processor is configured to train a neural network to learn to generate a plurality of sub-concept outputs from a first plurality of inputs of the plurality of digital input signals. The processor is also configured to use the plurality of sub-concept outputs as a plurality of target outputs for a plurality of top-level inputs of the plurality of digital input signals.

In the eye blink example herein, the IONN is described as:
Output={VEyeIsTrue, FieldFP, FieldF, FieldO, MorphHgt, MorphL, MorphR},
Input={CorrFp, AsymFp, DelFp, CorrF, RatF, AsymF, CorrO, RatO, AsymO, HgtLFp, HgtRatLRFp, DurLFp, AlpLFp, DurRFp, AlphRFp}
Hidden=7

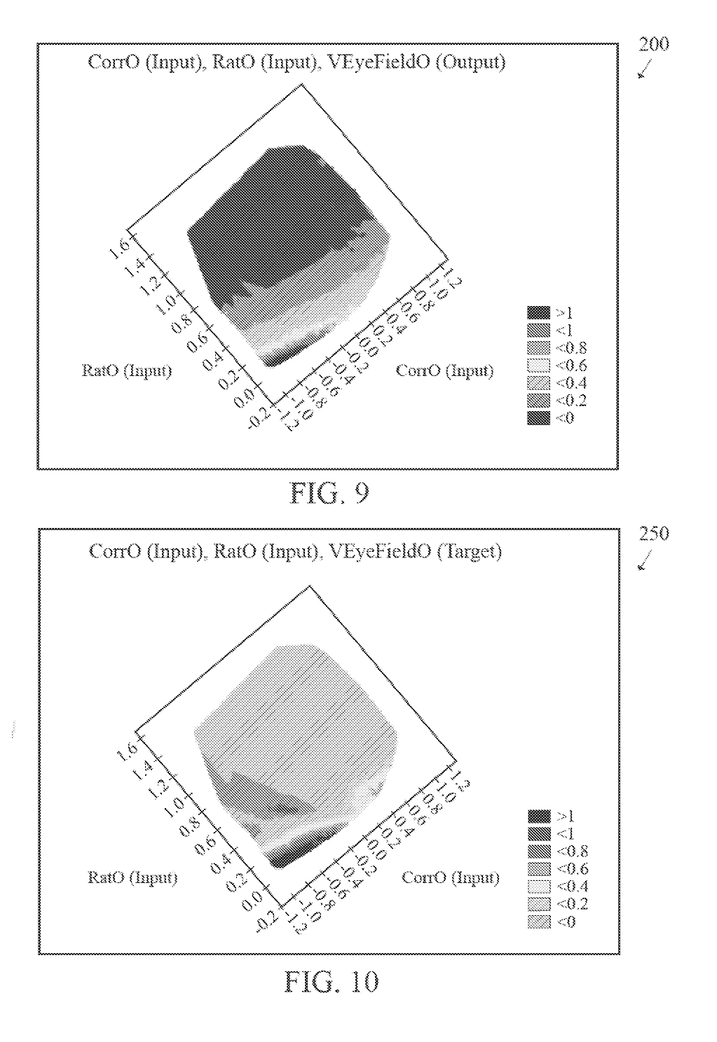

The graphs shown in FIGS. 9-10 show 3D transfer functions for the FieldO sub-concept. FieldO has three inputs, of which two are shown on the X and Y axis. The Z axis is shown in grayscale, and is the fuzzy Boolean (0-1) representing the truth of the sub-concept. The graphs are displayed as a pair, with the first showing the output of the sub-concept NN 200 and the second showing the predicted (learned) value of the IONN 250. The interpolation between datapoints is performed by a Wafer plot (Statistica).

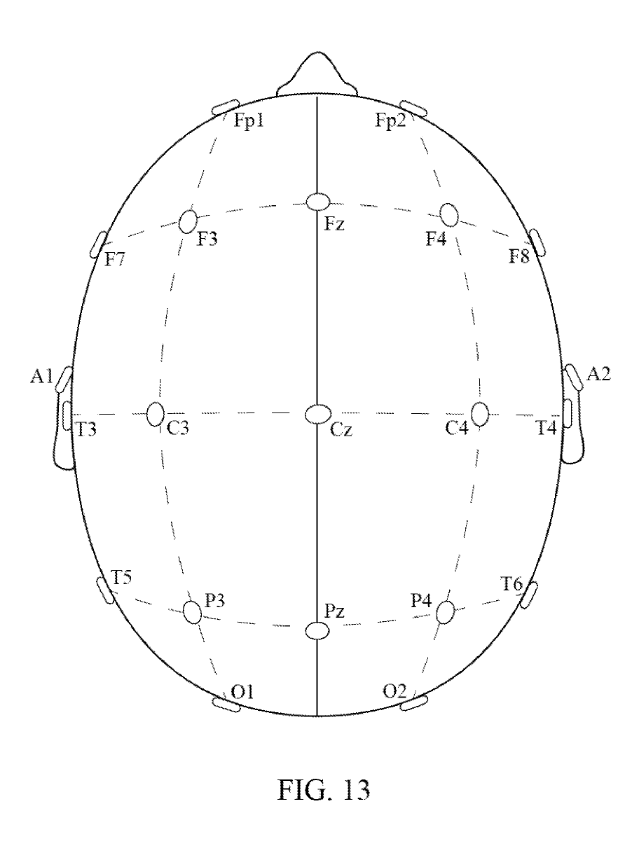

FieldO represents the electric field of the candidate eye blink event at the occipital (back of the head) electrode positions O1 and O2, as seen in FIG. 13. CorrO is the average correlation between the occipital (O1-Cz and O2-Cz) and frontal-polar channels (Fp1-Cz and Fp2-Cz). The tendency rules that describe this sub-concept are:
CorrO˜−1≈>FieldO=true
RatO<21 1≈>FieldO=true

From the transfer function it is evident that for true-positive cases (i.e. FieldO˜1) CorrO is usually negative and large, close to −1.0. RatO is the ratio of the event's height at the occipital channels compared to the frontal-polar channels. It is also clear that the amplitude of the eye blink in the occipital channels should be no larger than about ⅓ the size of the event in the frontal-polar channels. Both of these findings are supported by the tendency rules.

The FieldO Target (the value used for training the IONN) and Output (the predicted value from trained IONN) graphs are visually similar and the correlation for the train, test and validation sets is extremely high, ˜0.94. The most significant difference appears near the point CorrO=0.4 and RatO=0.2 where FieldO>0.5, which is unexpected from the previously presented tendency rules. Thus, the hypothesis is that some of the true positive training cases (VEyelsTrue=1) do not have an electric field that reaches the occipital channels, but that an unrelated positively correlated signal (CorrO>0.0) is found. Because the sub-concept is trained to match the target value VEyelsTrue, as the surrogate for FieldO, these cases are incorrectly learned, resulting in the large value of FieldO Target near CorrO=0.4 and RatO=0.2. Because the IONN is constrained and cannot learn FieldO exactly, and because it uses inputs not available to FieldO, these cases without an eye blink representation in the occipital channels) can be learned without resorting to use of the unrelated positive signal.

Benefits and Preferred Implementation

The IONN is not limited to the field and type of example presented herein, its use is not restricted to MLP architectures and offers explanation capabilities to any standard NN model. All that is required is the ability to identify sub-concepts and their corresponding inputs. Also, there is no restriction that the inputs of the sub-concepts be mutually exclusive.

Using traditional NN tools, the IONN is developed via multiple training steps: each of the subconcept NNs is trained in turn, then predictions from each of the sub-concepts are generated and added to the training case spreadsheet, and finally the IONN is trained. The preferred implementation requires only identification of the top-level concept, and the sub-concepts and their associated inputs, then the training of the IONN proceeds without user intervention.

Additionally, the minimum number of IONN hidden nodes is determined by training IONN instances with increasing numbers of hidden nodes until all of the sub-concepts are successfully learned, e.g. correlation>0.95. An alternative approach is to increase the number of hidden nodes by finding the point where the accuracy of the top-level concept stops improving in deference to improvement of the sub-concept accuracies.

An additional improvement allows the NN developer to specify tendency rules that are automatically validated against the learned transfer functions. Inconsistent tendency rules and transfer functions indicate an incorrectly composed model. This information automatically results in reducing the number of hidden nodes or the splitting of sub-concepts into smaller units that are trained consistently with the tendency rules.

EEG Systems

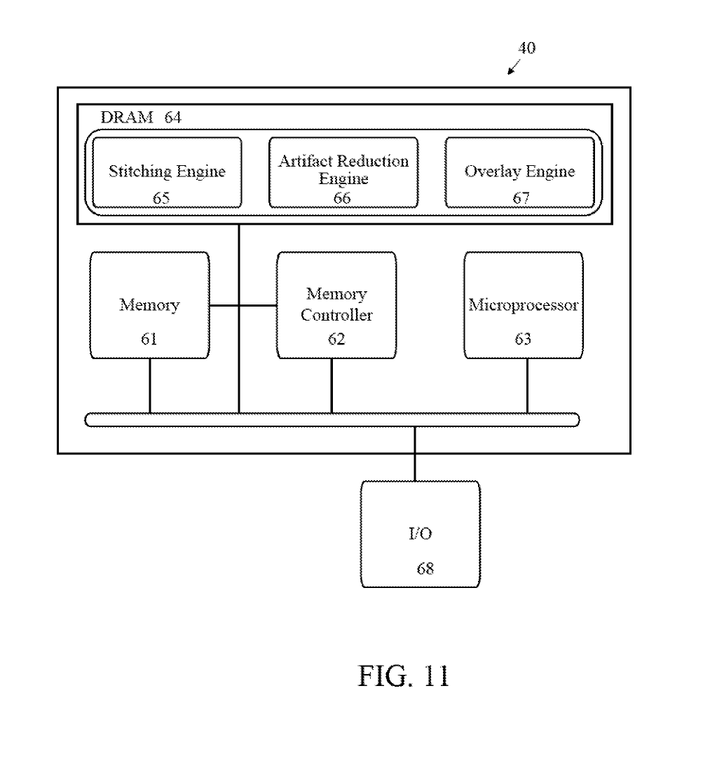

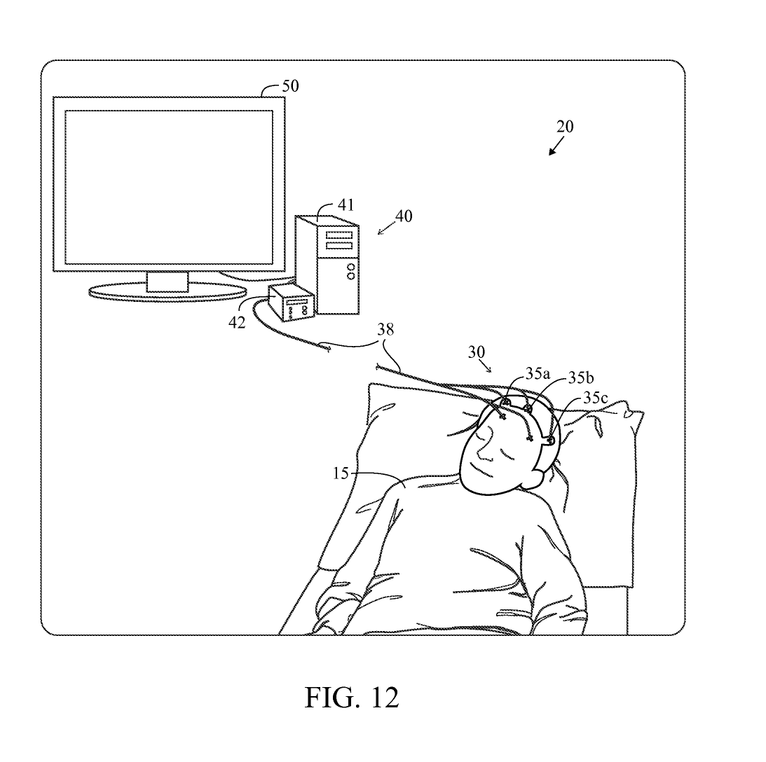

As shown in FIG. 12, an EEG system is generally designated 20. The system preferably includes a patient component 30, an EEG machine component 40 and a display component 50. The patient component 30 includes a plurality of electrodes 35a, 35b, 35c attached to the patient 15 and wired by cables 38 to the EEG machine component 40. The EEG machine component 40 comprises a CPU 41 and an amplifier component 42. The EEG machine component 40 is connected to the display component 50 for display of the combined EEG reports, and for switching from a processed EEG report to the combined EEG reports, or from the processed EEG report to an original EEG report. As shown in FIG. 11, the EEG machine component 40 preferably includes a stitching engine 65, an artifact reduction engine 66, an overlay engine 67, a memory 61, a memory controller 62, a microprocessor 63, a DRAM 64, and an Input/Output 68. Those skilled in the pertinent art will recognize that the machine component 40 may include other components without departing from the scope and spirit of the present invention.

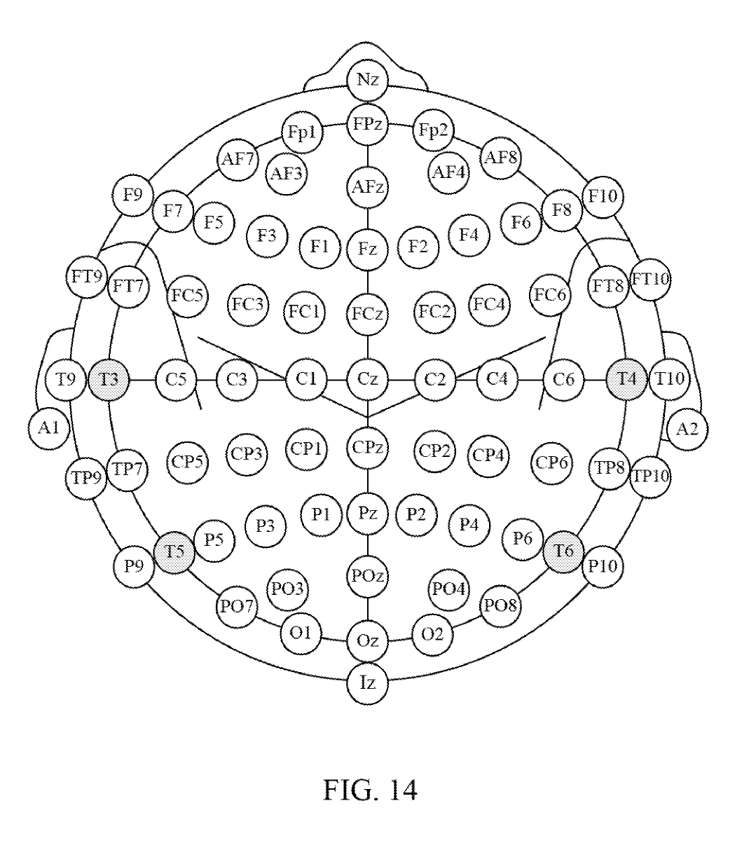

A patient has a plurality of electrodes attached to the patient's head with wires from the electrodes connected to an amplifier for amplifying the signal to a processor, which is used to analyze the signals from the electrodes and create an EEG recording. The brain produces different signals at different points on a patient's head. Multiple electrodes are positioned on a patient's head as shown in FIGS. 13 and 14. The number of electrodes determines the number of channels for an EEG. A greater number of channels produce a more detailed representation of a patient's brain activity. Preferably, each amplifier 42 of an EEG machine component 40 corresponds to two electrodes 35 attached to a patient's 15 head. The output from an EEG machine component 40 is the difference in electrical activity detected by the two electrodes. The placement of each electrode is critical for an EEG report since the closer the electrode pairs are to each other, the less difference in the brainwaves that are recorded by the EEG machine component 40. A more thorough description of an electrode utilized with the present invention is detailed in Wilson et al., U.S. Pat. No. 8,112,141 for a Method And Device For Quick Press On EEG Electrode, which is hereby incorporated by reference in its entirety. The EEG is optimized for automated artifact filtering. The EEG recordings are then processed using neural network algorithms to generate a processed EEG recording, which is analyzed for display.

Algorithms for removing artifact from EEG typically use Blind Source Separation (BSS) algorithms like CCA (canonical correlation analysis) and ICA (Independent Component Analysis) to transform the signals from a set of channels into a set of component waves or “sources.” The sources that are judged as containing artifact are removed and the rest of the sources are reassembled into the channel set.

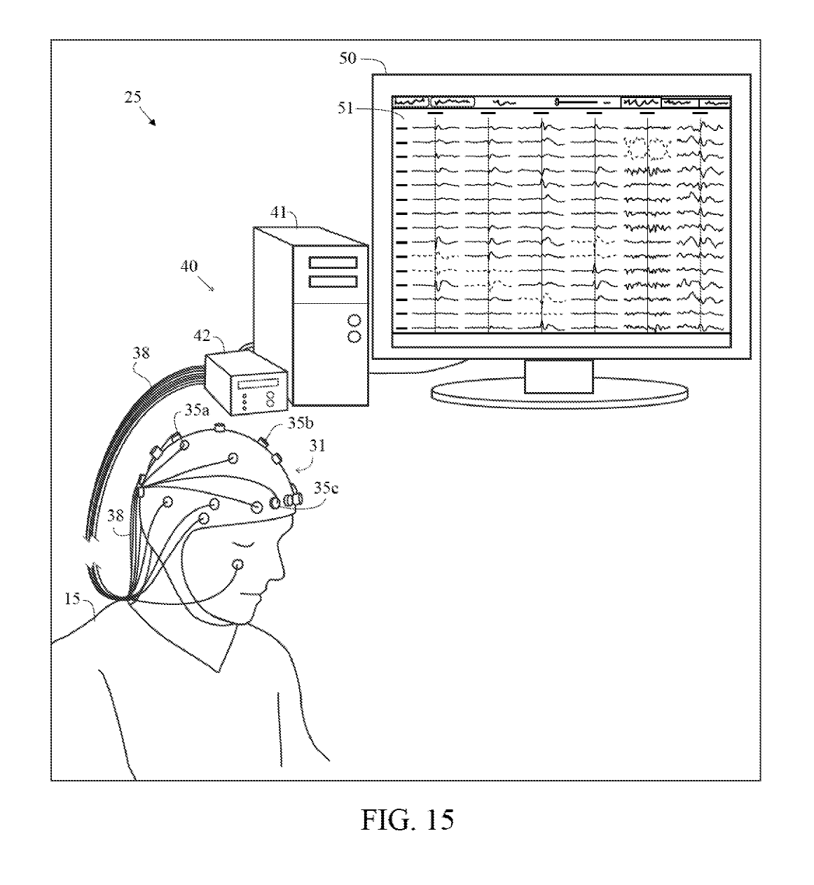

FIG. 15 illustrates a system 25 for a user interface for automated artifact filtering for an EEG. A patient 15 wears an electrode cap 31, consisting of a plurality of electrodes 35a-35c, attached to the patient's head with wires 38 from the electrodes 35 connected to an EEG machine component 40 which consists of an amplifier 42 for amplifying the signal to a computer 41 with a processor, which is used to analyze the signals from the electrodes 35 and create an EEG recording 51, which can be viewed on a display 50. A button on computer 41, either through a keyboard or touchscreen button on display 50 allows for the application of a plurality of filters to remove the plurality of artifacts from the EEG and generate a clean EEG. A more thorough description of an electrode utilized with the present invention is detailed in Wilson et al., U.S. Pat. No. 8,112,141 for a Method And Device For Quick Press On EEG Electrode, which is hereby incorporated by reference in its entirety. The EEG is optimized for automated artifact filtering. The EEG recordings are then processed using neural network algorithms to generate a processed EEG recording which is analyzed for display.

The system for training a neural network for detecting artifacts in EEG recordings includes a plurality of electrodes for generating a plurality of EEG signals, a processor connected to the plurality of electrodes to generate an EEG recording from the plurality of EEG signals, and a display connected to the processor for displaying an EEG recording. Preferably, the processor is configured to train a neural network to learn to generate a plurality of sub-concept outputs from a first plurality of inputs. The processor is also configured to use the plurality of sub-concept outputs as a plurality of target outputs for a plurality of top-level inputs.

Preferably, the plurality of top-level inputs comprises at least one of CorrFp, AsymFp, DelFp, CorrF, RatF, AsymF, CorrO, RatO, AsymO, HgtLFp, HgtRatLRFp, DurLFp, AlpLFp, DurRFp, and AlphRFp.

Preferably, the plurality of target outputs comprises at least one of VEyeIsTrue, FieldFP, FieldF, FieldO, MorphHgt, MorphL and MorphRThe system for training a neural network is preferably utilized for EEG recordings.

Alternatively, the final output is a loan score for a loan applicant. In this example, the plurality of digital input signals comprises at least one of a value for a monthly salary income for the loan applicant, a value for monthly rental income for the loan applicant, a value of a collateral for the loan, a value for a monthly car payment for the loan applicant, and a value of a number of years employed for the loan applicant. The plurality of sub-concept outputs comprises at least one of a total income value for the loan applicant, a total debt value for the loan applicant, and a total work experience value for the loan applicant.

Alternatively, the final output is a voice recognition command. The plurality of digital input signals comprises a plurality of audio signals from a user. The plurality of sub-concept outputs comprises a plurality of words.

Alternatively, the final output is a bankruptcy decision. The plurality of digital input signals comprises a plurality of assets of an entity and a plurality of debts of the entity. The plurality of sub-concept outputs comprises a value for a total amount of assets for the entity and a value for a total amount of debts of the entity.

Those skilled in the pertinent art will recognize that the system and method for training neural networks may be used with numerous NN applications without departing from the scope and spirit of the present invention.

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes modification and substitutions of equivalents may be made therein without departing from the spirit and scope of this invention which is intended to be unlimited by the foregoing except as may appear in the following appended claim. Therefore, the embodiments of the invention in which an exclusive property or privilege is claimed are defined in the following appended claims.

I claim as my invention:

1. A system for training a neural network, the system comprising:
a source for generating a plurality of digital input signals;
a processor connected to the source to receive from the plurality of digital input signals from the source; and
a display connected to the processor for displaying a final output;
wherein the processor is configured to train a neural network to learn to generate a plurality of sub-concept outputs from a first plurality of inputs of the plurality of digital input signals;
wherein the processor is configured to use the plurality of sub-concept outputs as a plurality of target outputs for a plurality of top-level inputs of the plurality of digital input signals.

2. The system according to claim 1 wherein the plurality of sub-concept outputs limits the number of potential models that fit both the input and output data for the neural network.

3. The system according to claim 1 wherein the accuracy of the neural network is greater than 0.9.

4. The system according to claim 1 wherein a maximum number of a plurality of hidden nodes is determined by finding a point wherein an accuracy of the top-level concept stops improving in deference to improvement of the sub-concept accuracies.

5. The system according to claim 1 further comprising:
wherein the final output is a loan score for a loan applicant;
wherein the plurality of digital input signals comprises at least one of a value for a monthly salary income for the loan applicant, a value for monthly rental income for the loan applicant, a value of a collateral for the loan, a value for a monthly car payment for the loan applicant, a value of a number of years employed for the loan applicant; and
wherein the plurality of sub-concept outputs comprises at least one of a total income value for the loan applicant, a total debt value for the loan applicant, and a total work experience value for the loan applicant.

6. The system according to claim 1 further comprising:
wherein the final output is a voice recognition command;
wherein the plurality of digital input signals comprises a plurality of audio signals from a user; and
wherein the plurality of sub-concept outputs comprises a plurality of words.

7. The system according to claim 1 further comprising:
wherein the final output is a bankruptcy decision;
wherein the plurality of digital input signals comprises a plurality of assets of an entity and a plurality of debts of the entity; and
wherein the plurality of sub-concept outputs comprises a value for a total amount of assets for the entity and a value for a total amount of debts of the entity.

8. A method for training a neural network, the method comprising:
generating a plurality of digital input signals from a machine comprising a source, a processor and a display;
training a neural network to learn to generate a plurality of sub-concept outputs from a first plurality of inputs of the plurality of digital input signals; and
using the plurality of sub-concept outputs as a plurality of target outputs for a plurality of top-level inputs of the plurality of digital input signals.

9. The method according to claim 8 wherein the plurality of sub-concept outputs limits the number of potential models that fit both the input and output data for the neural network.

10. The method according to claim 8 wherein the accuracy of the neural network is greater than 0.9.

11. The method according to claim 8 wherein a maximum number of a plurality of hidden nodes is determined by finding a point wherein an accuracy of the top-level concept stops improving in deference to improvement of the sub-concept accuracies.

12. The method according to claim 10 wherein the plurality of digital input signals comprises at least one of CorrFp, AsymFp, DelFp, CorrF, RatF, AsymF, CorrO, RatO, AsymO, HgtLFp, HgtRatLRFp, DurLFp, AlpLFp, DurRFp, and AlphRFp; wherein the plurality of sub-concept outputs comprises at least one of VEyeIsTrue, FieldFP, FieldF, FieldO, MorphHgt, MorphL and MorphR.

13. The method according to claim 10 further comprising:
wherein a final output is a loan score for a loan applicant;
wherein the plurality of digital input signals comprises at least one of a value for a monthly salary income for the loan applicant, a value for monthly rental income for the loan applicant, a value of a collateral for the loan, a value for a monthly car payment for the loan applicant, a value of a number of years employed for the loan applicant; and
wherein the plurality of sub-concept outputs comprises at least one of a total income value for the loan applicant, a total debt value for the loan applicant, and a total work experience value for the loan applicant.

14. The method according to claim 10 further comprising:
wherein a final output is a voice recognition command;
wherein the plurality of digital input signals comprises a plurality of audio signals from a user; and
wherein the plurality of sub-concept outputs comprises a plurality of words.

15. The method according to claim 10 further comprising:
wherein a final output is a bankruptcy decision;
wherein the plurality of digital input signals comprises a plurality of assets of an entity and a plurality of debts of the entity; and
wherein the plurality of sub-concept outputs comprises a value for a total amount of assets for the entity and a value for a total amount of debts of the entity.

16. A system for training a neural network for detecting artifacts in EEG recordings, the system comprising:
a plurality of electrodes for generating a plurality of EEG signals;
a processor connected to the plurality of electrodes to generate an EEG recording from the plurality of EEG signals; and
a display connected to the processor for displaying an EEG recording;
wherein the processor is configured to train a neural network to learn to generate a plurality of sub-concept outputs from a first plurality of inputs;
wherein the processor is configured to use the plurality of sub-concept outputs as a plurality of target outputs for a plurality of top-level inputs.

17. The system according to claim 16 wherein the plurality of top-level inputs comprises at least one of CorrFp, AsymFp, DelFp, CorrF, RatF, AsymF, CorrO, RatO, AsymO, HgtLFp, HgtRatLRFp, DurLFp, AlpLFp, DurRFp, and AlphRFp.

18. The system according to claim 16 wherein the plurality of target outputs comprises at least one of VEyeIsTrue, FieldFP, FieldF, FieldO, MorphHgt, MorphL and MorphR.
